(19) United States
(12) Patent Application Publication
(10) Pub. No.: US 2013/0250033 A1
(43) Pub. Date: Sep. 26, 2013

(54) INTERPHONE, INTERPHONE SYSTEM AND METHOD FOR ADJUSTING BRIGHTNESS OF DISPLAY PANEL OF INTERPHONE

(71) Applicants: CHI-CHIH WANG, Tu-Cheng (TW); TZU-TE WANG, Tu-Cheng (TW); KAI-CHIANG YANG, Tu-Cheng (TW); WAN-YING LIAO, Shenzhen City (CN)

(72) Inventors: CHI-CHIH WANG, Tu-Cheng (TW); TZU-TE WANG, Tu-Cheng (TW); KAI-CHIANG YANG, Tu-Cheng (TW); WAN-YING LIAO, Shenzhen City (CN)

(21) Appl. No.: 13/663,378

(22) Filed: Oct. 29, 2012

(30) Foreign Application Priority Data
Mar. 20, 2012 (CN) 201210074152.7

(51) Int. Cl. H04N 7/14

(52) U.S. Cl. 348/14.02; 348/E07.077

(57) ABSTRACT

An interphone includes a processor, and a microphone, a camera, a wireless communicating module, a speaker and a display panel electrically connected with the processor. The interphone further includes a brightness detecting device electrically connected with the processor. The brightness detecting device detects a brightness of outer environment. When the interphone is communicating with other interphones, the processor adjusts a brightness of the display panel according to the brightness of outer environment detected by the brightness detecting device. An interphone system and a method for adjusting a brightness of a display panel of an interphone are also provided.

### BACKGROUND

1. Technical Field

The disclosure generally relates to a communication device, especially an interphone, an interphone system and a method for adjusting a brightness of a display panel of the interphone.

2. Description of Related Art

Nowadays, interphones are widely used in a plurality of applications such as public security, transportation and industry manage. An interphone generally includes a display panel and a camera. The camera is used to capture video information of a user. The video information is transmitted to another interphone and displayed in the display panels of the another interphone. However, in a dark environment, the video information obtained by the camera is unclear, therefore affecting a quality of communication between the two interphones.

What is needed, therefore, is an interphone, an interphone system and a method for adjusting a brightness of a display panel of the interphone which can overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of an interphone system in accordance with one embodiment of the disclosure.

FIG. 2 is a schematic view of an interphone in FIG. 1.

FIG. 3 is a schematic view of an LED light source in FIG. 2.

FIG. 4 is a flow chart of controlling a brightness of a display panel of the interphone in FIG. 2.

### DETAILED DESCRIPTION

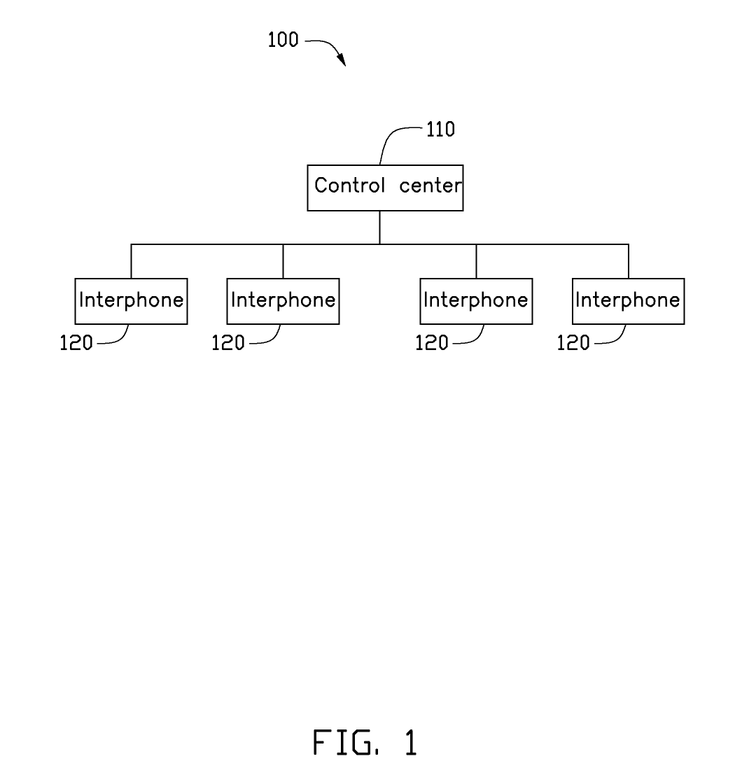

Referring to FIG. 1, an interphone system 100 in accordance with one embodiment of the disclosure is shown. The interphone system 100 includes a control center 110 and a plurality of interphones 120 communicating with the control center 110.

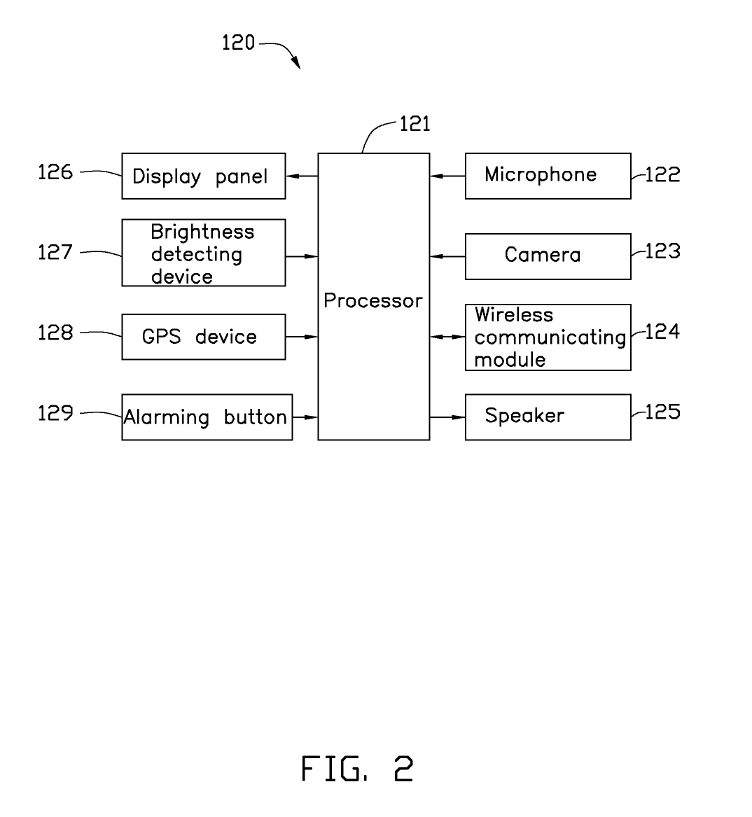

Referring also to FIG. 2, each interphone 120 includes a processor 121, and a microphone 122, a camera 123, a wireless communicating module 124, a speaker 125, a display panel 126 and a brightness detecting device 127 electrically connected with the processor 121.

The microphone 122 is configured to receive audio information of a user and transmit the audio information to the processor 121.

The camera 123 is configured to receive video information of the user, such as the face or the dress of the user, and transmit the video information to the processor 121.

The processor 121 receives the audio information from the microphone 122 and the video information from the camera 123, and transmits the audio information and the video information to the control center 110 and/or other interphones 120 by the wireless communicating module 124. At the same time, the wireless communicating module 124 can also receive the audio information and the video information of the control center 110 and/or other interphones 120, and transmits them to the processor 121.

The speaker 125 receives the audio information of the control center 110 and/or the other interphone 120. The speaker 125 broadcasts the audio information of the control center 110 and/or other interphones 120 to the user.

The display panel 126 receives the video information from the control center 110 and/or other interphone 120. The display panel 126 displays the video information of the control center 110 and/or other interphones 120 to the user.

The brightness detecting device 127 is configured to detect a brightness of outer environment. When the interphone 120 is communicated with the other interphones 120, the processor 121 adjusts the brightness of the display panel 126 according to the brightness of outer environment. That is, in a dark environment, the processor 121 will increase the brightness of the display panel 126 to illuminate the user, thereby obtaining clear video information from the camera 123. When the outer environment has enough brightness to illuminate the user, the processor 121 will maintain the brightness of the display panel 126 just to make ensure the user can see a content of the display panel 126 clearly. Preferably, when the communication between the two interphones 120 is ended or the interphone 120 does not work for a period of time, the processor 121 can decrease the brightness of the display panel 126 to save the energy.

Preferably, the interphone 120 can further include a GPS (Global Position System) device 128 electrically connected with the processor 121. The GPS device 128 is configured to detect a position of the interphone 120 and transmits the position to the control center 110 and/or other interphone 120 by the wireless communicating module 124. Therefore, in the control center 110 or any one of the interphones 120, user can look over the position of any other interphones 120.

Preferably, the interphone 120 can further include an alarming button 129. The user presses down the alarm button 129 to generate an alarm signal. The alarm signal is then transmitted to the control center 110 and/or other interphones 120 by the wireless communicating module 124. After receiving the alarm signal, the control center 110 and/or the display panel 126 of other interphones 120 will show the position of the interphone 120 which generate the alarm signal.

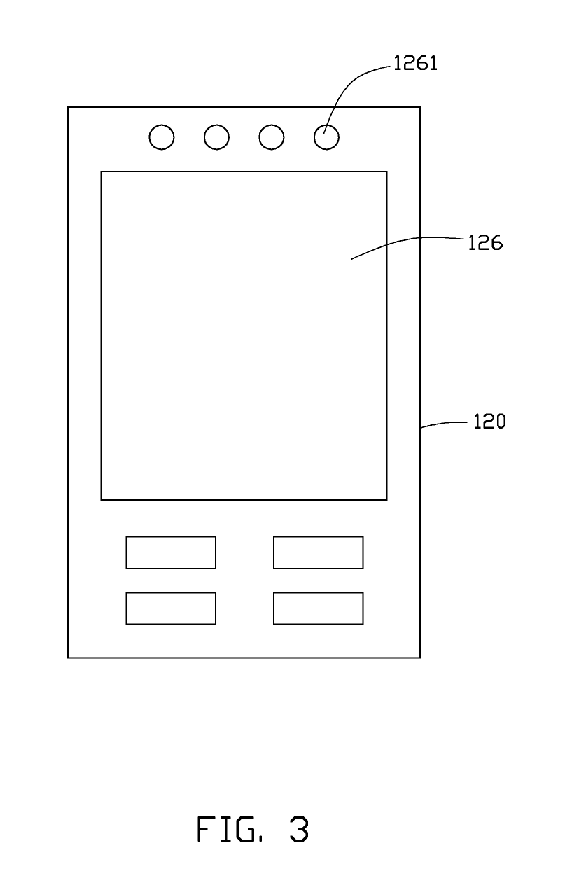

Referring to FIG. 3, the interphone 120 can further includes an LED light source 1261 arranged on the display panel 126. The LED light source 1261 generally includes several LED units. Preferably, the number of the LED units is in a range from 3 to 6. When the interphone 120 is in a dark environment, the LED light source 1261 is turned on to illuminate the user. In addition, the processor 121 can adjust a brightness of the LED light source 1261 according to the brightness of outer environment.

In an alternative embodiment, the interphone system 100 can only include interphones 120 to achieve the communication between the interphones 120 without the control center 110.

In the interphone system 100 described above, the brightness of outer environment is detected by the brightness detecting device 127. When in a dark environment, the processor 121 can increase the brightness of the display panel 126 to illuminate the user of the interphone 120, therefore the camera 123 can capture a clear image information. When the communication between the interphones 120 is ended or the interphone 120 does not work for a period of time, the processor 121 can decrease the brightness of the display panel 126 to save the energy.

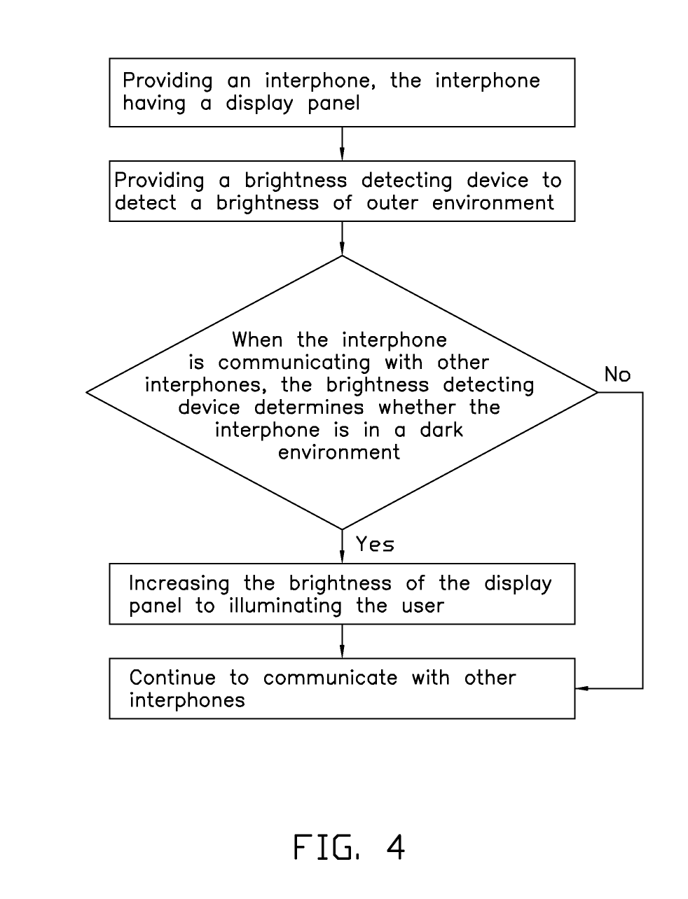

Referring to FIG. 4, a method for adjusting a brightness of a display panel of an interphone is also provided. The method includes following steps.

An interphone 120 is provided. The interphone 120 includes a processor 121 and a microphone 122, a camera 123, a wireless communicating module 124, a speaker 125 and a display panel 126 communicating with the processor 121. The microphone 122 is configured to receive audio information of the user. The camera 123 is configured to receive video information of the user. The processor 121 transmits the audio information and the video information to other interphones 120 by the wireless communicating module 124. At the same time, the wireless communicating module 124 receives the audio information and the video information from other interphones 120. The speaker 125 is configured to broadcast the audio information of other interphones 120 to the user. The display panel 126 is configured to display the video information of other interphones 120 to the user.

A brightness detecting device 127 is provided. The brightness detecting device 127 is electrically connected with the processor 121. The brightness detecting device 127 is configured to detect a brightness of outer environment. When the interphone 120 is communicated with other interphones 120, the processor 121 adjusts the brightness of the display panel 126 according to the brightness of outer environment detected by the brightness detecting device 127.

Preferably, a GPS device 128 can further be provided. The GPS device 128 detects a position of the interphone 120 and transmits the position to the other interphones 120 by the wireless communicating module 124.

Preferably, an alarm button 129 is further provided. The user presses down the alarm button 129 to generate an alarm signal. The alarm signal is then transmitted to the control center 110 or other interphones 120 by the wireless communicating module 124. After receiving the alarm signal, the display panel 126 of other interphones 120 will show the position of the interphone 120 which generate the alarm signal for people going to the position to rescue.

The interphone system 100 or the interphone 120 can be applied to the housing for a better management. In an alternative embodiment, the interphone system 100 or the interphone 120 can also be applied to the hospital to provide a better service to the patients. In addition, the interphone system 100 or the interphone 120 can also be used in a plurality of application such as the industry, the prison, the school and the elevator.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An interphone, comprising:
a processor;
a microphone configured to receive audio information from a user and transmit the audio information to the processor;
a camera configured to receive video information of the user and transmit the video information to the processor;
a wireless communicating module configured to transmit the audio information and the video information to other interphones, the wireless communicating module further receiving audio information and video information of the other interphones and transmitting them to the processor;
a speaker, receiving the audio information of the other interphones from the processor and broadcasting the audio information of other interphones to the user;
a display panel, receiving the video information of the other interphones from the processor and displaying the video information of the other interphones to the user; and
a brightness detecting device electrically connected with the processor, the brightness detecting device being configured to detect a brightness of outer environment, when the interphone is communicating with the other interphones, the processor adjusting a brightness of the display panel according to the brightness of outer environment detected by the brightness detecting device.

2. The interphone of claim 1, further comprising a GPS device electrically connected with the processor, the GPS device detecting a position of the interphone and transmitting the position to other interphones by the wireless communicating module.

3. The interphone of claim 2, further comprising an alarm button, the user pressing down the alarm button to generate an alarm signal, the alarm signal being transmitted to the other interphones by the wireless communicating module, the other interphones receiving the alarm signal and showing the position of the interphone in the display panel.

4. The interphone of claim 1, further comprising an LED light source arranged on the display panel, the processor adjusting a brightness of the LED light source to illuminate the user according to the brightness of outer environment detected by the brightness detecting device.

5. An interphone system, comprising:
a control center; and
a plurality of interphones communicating with the control center, each of the interphone comprising:
a processor;
a microphone configured to receive audio information of a user and transmit the audio information to the processor;
a camera configured to receive video information of the user and transmit the video information to the processor;
a wireless communicating module configured to transmit the audio information and the video information to the control center and/or other interphones, the wireless communicating module further receiving audio information and video information of the control center and/or the other interphones and transmitting them to the processor;
a speaker, receiving the audio information of the control center and/or the other interphones from the processor and broadcasting the audio information of the other interphones to the user;
a display panel, receiving the video information of the control center and/or the other interphones from the processor and displaying the video information of the other interphones to the user; and
a brightness detecting device electrically connected with the processor, the brightness detecting device configured to detect a brightness of outer environment, when the interphone is communicating with the other interphones, the processor adjusting a brightness of the display panel according to the brightness of outer environment detected by the brightness detecting device.

6. The interphone system of claim 5, further comprising a GPS device electrically connected with the processor, the GPS device detecting a position of the interphone and transmitting the position to the control center and/or other interphones by the wireless communicating module.

7. The interphone of claim 6, further comprising an alarm button, the user pressing down the alarm button to generate an alarm signal, the alarm signal being transmitted to the control center and/or other interphones by the wireless communicating module, the control center and/or other interphones receiving the alarm signal and showing the position of the interphone in the display panel.

8. The interphone of claim 5, further comprising an LED light source arranged on the display panel, the processor adjusting a brightness of the LED light source to illuminating the user according to the brightness of outer environment detected by the brightness detecting device.

9. A method for adjusting a brightness of a display panel of an interphone, comprising following steps:
providing an interphone, the interphone comprising:
processor;
a microphone configured to receive audio information of a user and transmit the audio information to the processor;
a camera configured to receive video information of the user and transmit the video information to the processor;
a wireless communicating module configured to transmit the audio information and the video information to other interphones, the wireless communicating module further receiving audio information and video information of the other interphones and transmitting them to the processor;
a speaker, receiving the audio information of the other interphones from the processor and broadcasting the audio information of the other interphones to the user; and
a display panel, receiving the video information of the other interphones from the processor and displaying the video information of the other interphones to the user; and
providing a brightness detecting device, the brightness detecting device electrically connected with the processor, the brightness detecting device configured to detect a brightness of outer environment, when the interphone is communicating with other interphones, the processor adjusting a brightness of the display panel according to the brightness of outer environment detected by the brightness detecting device.

10. The method of claim 9, further comprising a GPS device electrically connected with the processor, the GPS device detecting a position of the interphone and transmitting the position to other interphones by the wireless communicating module.

11. The method of claim 10, further comprising an alarm button, the user pressing down the alarm button to generate an alarm signal, the alarm signal being transmitted to other interphones by the wireless communicating module, the other interphones receiving the alarm signal and showing the position of the interphone in the display panel.

12. The method of claim 9, further comprising an LED light source arranged on the display panel, the processor adjusting a brightness of the LED light source to illuminating the user according to the brightness of outer environment detected by the brightness detecting device.
